(19) United States
(12) Patent Application Publication
(10) Pub. No.: US 2026/0314515 A1
(43) Pub. Date: Oct. 15, 2026

(54) METHOD FOR ASCERTAINING OCCUPANCY STATE OF THREE-POINT HITCH

(71) Applicant: Deere & Company, Moline, IL (US)

(72) Inventors: AXEL FLEMMING, Mannheim (DE); FLORIAN SCHOTT, Mannheim (DE); NORBERT FRITZ, Ilvesheim (DE); RICHARD STARCK, Falkenstein (DE)

(21) Appl. No.: 19/401,622

(22) Filed: Nov. 26, 2025

(30) Foreign Application Priority Data
Apr. 11, 2025 (EP) 25170114.0

(51) Int. Cl. A01B 63/111; A01B 59/06

(52) U.S. Cl. CPC A01B 63/1117; A01B 59/066

(57) ABSTRACT

A method for ascertaining an occupancy state of a three-point hitch on an agricultural tractor is disclosed. The three-point hitch for receiving an accessory or implement comprises, on the tractor side, an upper link pivotably attached to an upper fastening point and lower links pivotably attached to lower fastening points. The lower links can be raised and lowered by a hydraulic lifting cylinder by actuating a hitch valve. When a constant flow cross section set at the hitch valve is identified, a control unit determines a speed of change in position occurring at the lower links by a displacement sensor and assesses the speed of change in position with regard to an ascertained deviation from a standard value predefined for an unoccupied state of the lower links. The control unit infers the presence of an accessory or ancillary implement attached to the lower links.

### CROSS-REFERENCE TO RELATED APPLICATIONS

This application claims priority to European Patent Application No. 25170114.0, filed Apr. 11, 2025, which is hereby incorporated by reference.

### TECHNICAL FIELD

The disclosure relates to a method for ascertaining an occupancy state of a three-point hitch on an agricultural tractor, which three-point hitch for receiving an accessory or ancillary implement comprises, on the tractor side, an upper link pivotably attached to an upper fastening point and also left-hand-side and right-hand-side lower links pivotably attached to left-hand-side and right-hand-side lower fastening points, which lower links can be raised and lowered by at least one hydraulic lifting cylinder by actuating a hitch valve.

### BACKGROUND

A three-point hitch is of conventional design and can be located either in the rear region or the front region of the agricultural tractor. In this case, quick-action arresting hooks provided on the upper link and also on the lower links allow latching with corresponding coupling points on the accessory or ancillary implement

### SUMMARY

The presence of an accessory or ancillary implement attached to the three-point hitch has a significant influence on the driving behavior as well as on the tyre contact forces of the agricultural tractor. This applies primarily when the accessory or ancillary implement is out of contact with the ground. This is, of course, the case with freely supported implements or additional weights, but also with ground-penetrating implements, provided they are in the raised position of the lower links intended for transport. Knowledge of the current occupancy state of the three-point hitch is of interest for operation of a driving dynamics control system, a tyre pressure control system or the like.

In view of this, the object is to specify a method of the type mentioned above which allows identification of an accessory or ancillary implement attached to a three-point hitch independently of the driver.

This object is achieved by a method for ascertaining an occupancy state of a three-point hitch on an agricultural tractor having the features of one or more embodiments disclosed herein.

In a method according to the disclosure for ascertaining an occupancy state of a three-point hitch on an agricultural tractor, the three-point hitch for receiving an accessory or ancillary implement comprises, on the tractor side, an upper link pivotably attached to an upper fastening point and also left-hand-side and right-hand-side lower links pivotably attached to left-hand-side and right-hand-side lower fastening points, which lower links can be raised and lowered by at least one hydraulic lifting cylinder by actuating a hitch valve. Here, when a constant flow cross section set at the hitch valve is identified, a control unit determines a speed of change in position occurring at the lower links by a displacement sensor and also assesses the speed of change in position with regard to an ascertained deviation from a standard value predefined for an unoccupied state of the lower links, wherein the control unit infers the presence of an accessory or ancillary implement attached to the lower links if (i) the deviation occurring during lowering of the lower links is greater in magnitude than a predefined upper limit value or (ii) the deviation occurring during lifting of the lower links is lower in magnitude than a predefined lower limit value.

In other words, operating states of the three-point hitch are used for measuring the lowering or lifting speed occurring at the lower links, in which operating states the at least one hydraulic lifting cylinder is retracted or extended without any significant change in the flow cross section set at the hitch valve. This is the case, for example, when the lower links are lowered from a raised transportation position to a lowered working position, and vice versa. The lowering or lifting speed occurring at the lower links results here from a change in the lower link position over time, detected by the displacement sensor, or from a substitute variable which is clearly related thereto. The substitute variable may be, for example, the extended state of the at least one hydraulic lifting cylinder.

Thus, the weight of an accessory or ancillary implement suspended from the lower links in the range of several hundredweights up to more than one tonne leads in the first case (i) to an increase in the lowering speed and in the second case (ii) to a reduction in the lifting speed in comparison to an unoccupied or load-free state of the lower links. A deviation occurring in relation to the standard value predefined in this respect thus allows at least one qualitative statement with regard to the presence of an accessory or ancillary implement on the three-point hitch to be made on the precondition of a flow cross section at the hitch valve that remains constant during the measurement process. This information can be used, for example, to carry out suitable adjustment of weight-dependent operating parameters of corresponding vehicle systems, such as a driving dynamics control system, a tyre pressure control system or the like. It does not matter here whether the at least one hydraulic lifting cylinder is of single-acting or double-acting design.

The standard value can be variably predefined by the control unit in order to be able to accordingly take account of changes in the pressure conditions at the hitch valve detected by sensor. This is important when the lower links are raised by extending the at least one hydraulic lifting cylinder, especially when pressure is applied to the at least one hydraulic lifting cylinder by a high-pressure pump with a variable delivery volume flow as a component of a so-called load-sensing hydraulic system. Depending on the load requirement of further hydraulic consumers fed by the high-pressure pump, the volume flow passing through the hitch valve can be subject to certain fluctuations, which are manifested in a changed extension speed of the at least one hydraulic lifting cylinder and ultimately render corresponding adjustment of the standard value necessary.

Advantageous developments of the method according to the disclosure can be gathered from the one or more embodiments disclosed herein.

In order to rule out erroneous detection of the speed of change in position at the lower links caused by acceleration-induced external influences, provision may be made for the occupancy state to be ascertained by the control unit when it is identified by evaluating travel and/or operating state information provided via a data communication system that the agricultural tractor is travelling straight ahead at a constant speed of travel on substantially inclination-free ground or is stationary thereon. The presence of straight-ahead travel can be identified, inter alia, on the basis of a wheel steering angle set on steerable wheels of the agricultural tractor, whereas the speed of travel can be assessed by detection by sensor and evaluation of the wheel rotation speeds occurring at associated wheels of the agricultural tractor. In this case, the relevant travel and/or operating state information is usually available to the control unit on the data communication system, designed as a CAN bus, of the agricultural tractor.

Against this background, it is also conceivable for the control unit to terminate ascertaining of the occupancy state that has already started if it is identified by the control unit by evaluating the travel and/or operating state information provided via the data communication system that there is a change in the speed of travel, the direction of travel or the inclination of the ground that goes beyond a permissible tolerance range. The same applies if the flow cross section set at the hitch valve changes or a corresponding operating action by the driver with the intention of different actuation of the three-point hitch is identified.

Here, the control unit, for assessing the inclination of the ground, can evaluate inclination information and/or topography information, detected by sensor, of a navigation system permanently installed in the agricultural tractor or designed as a mobile terminal as a constituent part of the travel and/or operating state information. The topography information is usually present in the form of cartographic data in a memory unit communicating with the navigation system, whereas the inclination information can also be provided by an inertial measurement unit (IMU) or the like assigned to the tractor chassis. The topography and/or inclination information can then likewise be transmitted to the control unit via the data communication system or the CAN bus of the agricultural tractor.

Ascertaining of the occupancy state can be initiated by the control unit automatically when the agricultural tractor is put into operation, when it is identified during field cultivation that a headland has been reached, periodically after a predefined time period has elapsed and/or manually via a user interface. The situation of a headland being reached is identified, for example, by a headland management system, such as the so-called iTEC system from the manufacturer John Deere.

For the purpose of reducing possible measurement errors, provision may be made for ascertaining of the deviation occurring in relation to the predefined standard value being limited to a linear range of constant speed of change in position. In order to increase the linear range, possible influences resulting from non-linearities between the extended state and the movement speed of the at least one hydraulic lifting cylinder can be compensated for by the control unit by using a correction function determined for the model of lifting cylinder in question.

In order to be able to make a statement regarding the weight ratios of an accessory or ancillary implement attached to the lower links that goes beyond the mere presence of the accessory or ancillary implement, it is possible for the control unit, taking into account the geometry or lever ratios of the three-point hitch, said geometry or lever ratios being assumed to be known, to categorize the weight of an accessory or ancillary implement attached thereto in accordance with tensile force information provided by sensor and representing an action of load exerted on at least one of the two lower fastening points via the lower links, on the basis of an estimation of the center of gravity position based thereon. Knowledge of the center of gravity position or the approximate weight of the accessory or ancillary implement makes it possible to carry out more refined adjustment of the weight-dependent operating parameters of the corresponding vehicle systems of the agricultural tractor. Categorization can be performed in broad classes, such as “light”, “medium” and “heavy”.

Furthermore, the control unit, taking into account the lever ratios of the three-point hitch, said lever ratios being assumed to be known, can ascertain in magnitude the weight of the accessory or ancillary implement in accordance with tensile force information provided by sensor and representing an action of load exerted on at least one of the two lower fastening points via the lower links, on the basis of an estimation of the center of gravity position based thereon in conjunction with information relating to a current upper link length. Therefore, as a rule, the upper link can be changed mechanically by a threaded spindle or hydraulically in terms of its length between the upper fastening point on the agricultural tractor and the quick-action arresting hook, in order to be able to vary the inclination of an accessory or ancillary implement attached to the tractor. This in turn has corresponding effects on the lever ratios at the three-point hitch. The information to be transmitted to the control unit in this respect can either be input manually via the user interface or else detected directly at the upper link by a position sensor. Such a possibility is usually provided in any case for hydraulically length-adjustable upper links of conventional design.

Provision of the tensile force information by sensor is performed, for example, by a force measuring bolt. The force measuring bolt serves at the same time for pivotably mounting the associated lower link within the lower fastening point on the agricultural tractor.

Other features and aspects will become apparent by consideration of the detailed description, claims, and accompanying drawings.

### BRIEF DESCRIPTION OF THE DRAWINGS

The method according to the disclosure for ascertaining an occupancy state of a three-point hitch on an agricultural tractor is described in more detail hereinafter on the basis of the appended drawings. Components or assemblies with an equivalent or comparable function are identified here by the same reference signs.

FIG. 1 shows an example embodiment, illustrated as a block diagram, of the method according to the disclosure for ascertaining an occupancy state of a three-point hitch on an agricultural tractor.

FIG. 2a shows a view from the rear of an agricultural tractor equipped with a three-point hitch.

FIG. 2b shows an arrangement, included in the agricultural tractor, for executing the method illustrated in FIG. 1.

FIG. 3 shows an exemplary profile of the lower link position or of a control signal for actuating a hitch valve provided for changing the lower link position, in each case as a function of time when the lower links are lowered.

Like reference numerals are used to indicate like elements throughout the several figures.

### DETAILED DESCRIPTION

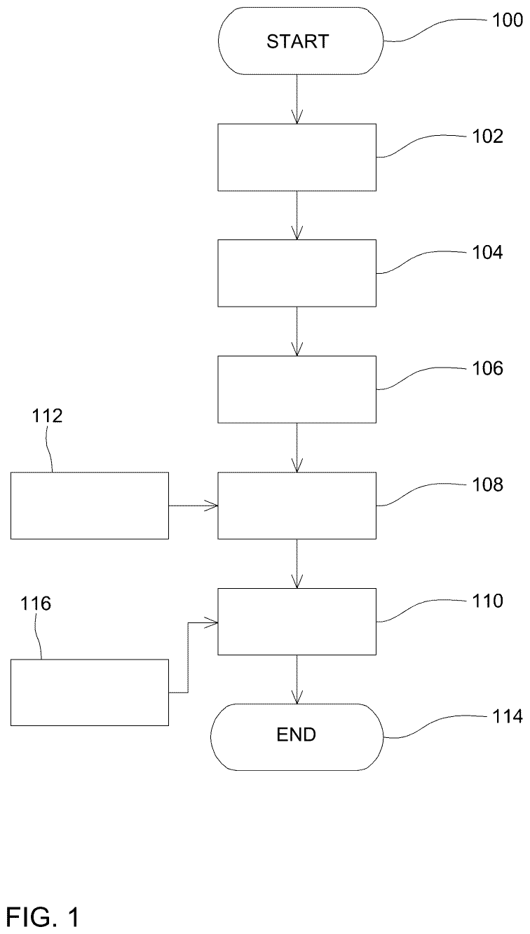

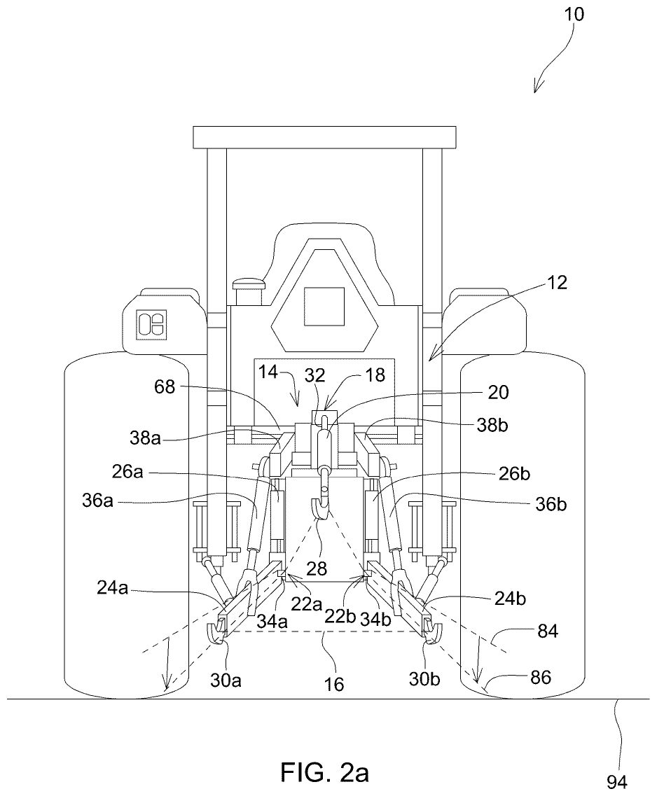

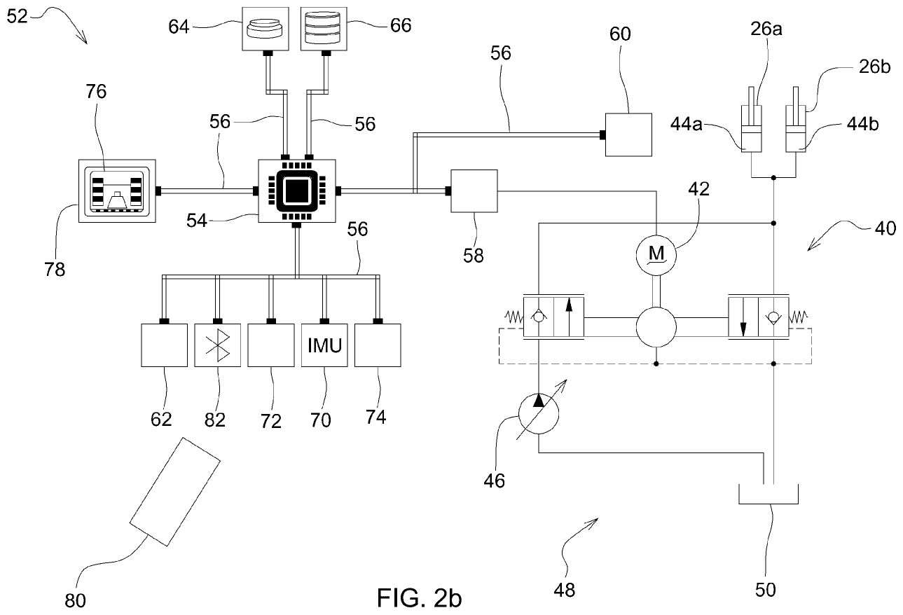

FIG. 1 shows an example embodiment, illustrated as a block diagram, of the method according to the disclosure for ascertaining an occupancy state of a three-point hitch on an agricultural tractor, with the arrangement according to FIG. 2b provided for executing the method being discussed first.

The agricultural tractor 10 shown in this connection in FIG. 2a is of conventional design and has, at least in the rear region 12 (optionally also in the front region), a three-point hitch 14 which, for receiving an accessory or ancillary implement 16 (not shown), comprises, on the tractor side, an upper link 20 pivotably attached to an upper fastening point 18 and also left-hand-side and right-hand-side lower links 24a, 24b pivotably attached to left-hand-side and right-hand-side lower fastening points 22a, 22b, which lower links can be raised and lowered by hydraulic lifting cylinders 26a, 26b. Quick-action arresting hooks 28, 30a, 30b provided on the upper link 20 and on the lower links 24a, 24b allow latching with corresponding coupling points on the accessory or ancillary implement 16.

To be more precise, the upper link 20 and the two lower links 24a, 24b are attached pivotably both in the horizontal and in the vertical direction in the region of their fastening points 18, 22a, 22b at their tractor-side end by associated ball joints 32, 34a, 34b. The lower links 24a, 24b are connected via associated lifting struts 36a, 36b to lifting arms 38a, 38b which can be pivoted by the hydraulic lifting cylinders 26a, 26b in order to raise and lower the lower links 24a, 24b.

Corresponding to the illustrations in FIGS. 2a and 2b, the hydraulic lifting cylinders 26a, 26b are of single-acting design, but they may also be of double-acting design.

A hitch valve 40 is used for the targeted retraction and extension of the hydraulic lifting cylinders 26a, 26b and thus for raising and lowering the lower links 24a, 24b, which hitch valve, by an electromotive drive 42, can be switched over between a pressure-applying position A, in which the working chambers 44a, 44b of the hydraulic lifting cylinders 26a, 26b can be connected to a high-pressure pump 46 with a variable delivery volume flow of a load-sensing hydraulic system 48 of the agricultural tractor 10, and a pressure-relieving position B for establishing a return connection to a reservoir 50. Typically, in addition to the hitch valve 40, further (hydraulic) components, such as, for example, a pressure-control valve, pressure-limiting valve, non-return valves or the like, are present, but these are omitted from FIG. 2b for reasons of clarity.

As can also be seen in FIG. 2b, the arrangement 52 integrated into a superordinate control device architecture of the agricultural tractor 10 comprises an electronic control unit 54 which, via a data communication system in the form of a CAN bus 56, with a valve controller 58 for actuating the electromotive drive 42 included in the hitch valve 40, a displacement sensor 60 for detecting the lower link position α or a corresponding extended state s of the hydraulic lifting cylinders 26a, 26b, a wheel steering angle sensor 62 for detecting a wheel steering angle set at steerable wheels of the agricultural tractor 10, a multiplicity of wheel rotation speed sensors 62 for detecting the wheel rotation speeds occurring at associated wheels of the agricultural tractor 10, a navigation system 64 for providing topography information which is stored in the form of cartographic data in a memory unit 66 communicating with the navigation system 64, an inertial measurement unit (IMU) 70 assigned to the tractor chassis 68, a force measuring bolt 72 for providing tensile force information by sensor at least one of the two lower fastening points 22a, 22b, an (optional) position sensor 74 for providing information relating to a current upper link length l, and a user interface 78 in the form of a touch-sensitive display 76. The navigation system 64 is either permanently installed in the agricultural tractor 10 or else designed as a mobile terminal 80, wherein the mobile terminal communicates wirelessly with the control unit 54 via a Bluetooth interface 82. As an alternative, a WLAN interface or the like can also be provided instead of the Bluetooth interface 82 for wireless data transmission.

The force measuring bolt 72 serves at the same time for pivotably mounting the associated lower link 24a, 24b within the lower fastening point 22a, 22b on the agricultural tractor 10, so that the tensile force information accordingly represents an action of load exerted on the lower fastening point 22a, 22b via the lower link 24a, 24b.

The method shown schematically in FIG. 1 and stored as corresponding program code in a working memory (not shown) of the control unit 54 is automatically initialized in a start step 100 when the agricultural tractor 10 is put into operation. In a departure from this, it is also possible for the initialization in the start step 100 to be performed when it is identified during field cultivation that a headland has been reached, periodically after a predefined time period has elapsed and/or manually via the user interface 78. The situation of a headland being reached is identified, for example, by a headland management system, such as the so-called iTEC system from the manufacturer John Deere.

Subsequently, in a first main step 102, the method continues with actually ascertaining the occupancy state of the three-point hitch 14 independently of the driver in that, when a constant flow cross section set at the hitch valve 40 is identified, the control unit 54, in a second main step 104, determines a speed of change in position occurring at the lower links 24a, 24b by the displacement sensor 60. According to the example, this is the case when the lower links 24a, 24b are lowered from a raised transportation position 84 to a lowered working position 86, and vice versa. The lowering or lifting speed occurring at the lower links 24a, 24b results here from a change in the lower link position α over time, detected by the displacement sensor 60, or from the extended state s of the hydraulic lifting cylinder 26a, 26b.

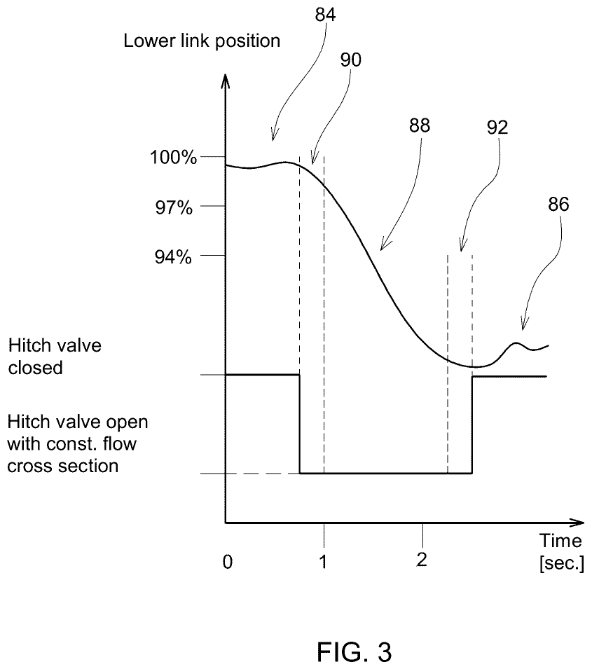

The speed of change in position occurring by the displacement sensor 60 is assessed or compared by the control unit 54 in a third main step 106 with regard to an ascertained deviation from a standard value predefined for an unoccupied state of the lower links 24a, 24b. A typical profile of the lower link position α or of the extended state s and of a control signal CURRENT generated by the control unit 54 for actuating the electromotive drive 42 of the hitch valve 40 is shown in FIG. 3 in each case as a function of time t by way of example for lowering the two lower links 24a, 24b from the raised transportation position 84 to the lowered working position 86.

For the purpose of reducing possible measurement errors, ascertaining of the deviation occurring in relation to the predefined standard value is limited to a linear range 88 of constant speed of change in position in the third main step 106. Non-linearities situated in the edge regions 90, 92 during opening and closing of the hitch valve 40 are thus screened out.

In order to increase the linear range 88, possible influences resulting due to non-linearities between the extended state s and the speed of travel ds/dt of the hydraulic lifting cylinders 26a, 26b are compensated for by the control unit 54 in the third main step 106 by applying a correction function which is intended for the model of lifting cylinder in question and is stored in the memory unit 66 as a quadratic function or a look-up table.

In a fourth main step 108, the control unit 54 infers the presence of the accessory or ancillary implement 16 attached to the lower links 24a, 24b if it is found in the third main step 106 that (i) the deviation occurring during lowering of the lower links 24a, 24b is greater in magnitude than a predefined upper limit value or (ii) the deviation occurring during lifting of the lower links 24a, 24b is lower in magnitude than a predefined lower limit value.

In other words, the two hydraulic lifting cylinders 26a, 26b are retracted or extended in a targeted manner and the lowering or lifting speed of the lower links 24a, 24b occurring in the process is measured. The latter results from the change, ascertained by the control unit 54, in the lower link position α over time detected by the displacement sensor 60 or the corresponding change in the extended states of the hydraulic lifting cylinders 26a, 26b over time.

Optionally, the standard value can be variably predefined by the control unit 54 in the third main step 106 with the objective of accordingly taking account of changes in the pressure conditions at the hitch valve 40 detected by sensor. This is of paramount importance when raising the lower links 24a, 24b by extending the hydraulic lifting cylinders 26a, 26b since pressure is applied to the working chambers 44a, 44b by the high-pressure pump 46 with a variable delivery volume flow as a constituent part of the load-sensing hydraulic system 48. Depending on the load requirement of further hydraulic consumers fed by the high-pressure pump 46, the volume flow passing through the hitch valve 40 can therefore be subject to certain fluctuations, which are manifested in a changed extension speed ds/dt of the hydraulic lifting cylinders 26a, 26b and ultimately render corresponding adjustment of the standard value necessary. Detection by sensor of the pressure conditions at the hitch valve 40 given by the delivery pressure of the high-pressure pump 46 is a constituent part of the load-sensing hydraulic system 48 and therefore is not shown separately in FIG. 2b.

The method according to the disclosure is based on the finding that the weight of the accessory or ancillary implement 16 suspended from the lower links 24a, 24b in the range of several hundredweights up to more than one tonne leads in the first case (i) to an increase in the lowering speed and in the second case (ii) to a reduction in the lifting speed in comparison to an unoccupied or load-free state of the lower links 24a, 24b. A deviation occurring in relation to the standard value predefined in this respect thus allows at least one qualitative statement with regard to the presence of the accessory or ancillary implement 16 on the three-point hitch 14 to be made on the precondition of a flow cross section at the hitch valve 40 that remains constant during the measurement process. This information is used, for example, in a fifth main step 110 to carry out suitable adjustment of weight-dependent operating parameters of corresponding vehicle systems, such as a driving dynamics control system, a tyre pressure control system or the like.

The method according to the disclosure is then ended in a concluding step 114.

In order to rule out erroneous detection of the speed of change in position at the lower links 24a, 24b caused by acceleration-induced external influences, provision is made for the occupancy state to be ascertained by the control unit 54 in the fourth main step 108 when it is identified in a first secondary step 112 by evaluating travel and/or operating state information provided via the CAN bus 56 that the agricultural tractor 10 is travelling straight ahead at a constant speed of travel on substantially inclination-free ground 94 or is stationary thereon. In order to assess the inclination of the ground 94, the control unit 54 evaluates inclination information detected by sensor as a constituent part of the travel and/or operating state information, which inclination information is provided by the inertial measurement unit 70, and/or the topography information of the navigation system 64.

The same applies correspondingly to the case in which it is identified by the control unit 54, in the first secondary step 112, by evaluating the travel and/or operating state information provided via the CAN bus 56 that there is a change in the speed of travel, the direction of travel or the inclination of the ground 94 that goes beyond a permissible tolerance range. Ascertaining of the occupancy state that has already started in the fourth main step 108 is then terminated, wherein the method according to the disclosure is immediately ended in the concluding step 114. The same applies if the flow cross section set at the hitch valve 40 changes or an operating action implemented by the driver via the user interface 78 with the intention of different actuation of the three-point hitch 14 is identified.

In order to be able to make a statement regarding the weight ratios of the accessory or ancillary implement 16 attached to the lower links 24a, 24b that goes beyond the mere presence of the accessory or ancillary implement, in an optional second secondary step 116 the control unit 54, taking into account the geometry or lever ratios of the three-point hitch 14, said geometry or lever ratios being assumed to be known, categorizes the weight of the accessory or ancillary implement 16 attached thereto in accordance with the tensile force information provided by sensor, on the basis of an estimation of the center of gravity position based thereon. Knowledge of the center of gravity position or the approximate weight of the accessory or ancillary implement 16 makes it possible to carry out more refined adjustment of the weight-dependent operating parameters of the corresponding vehicle systems of the agricultural tractor 10. Categorization is performed in broad classes, such as “light”, “medium” and “heavy”.

This can be extended with regard to ascertaining in magnitude the weight of the accessory or ancillary implement 16. For this purpose, the control unit 54 additionally includes the information relating to the current upper link length l provided via the CAN bus 56. Therefore, as a rule, the upper link 20 can be changed mechanically by a threaded spindle or hydraulically in terms of its length between the upper fastening point 18 on the agricultural tractor 10 and the quick-action arresting hook 28, in order to be able to vary the inclination of an accessory or ancillary implement 16 attached to the tractor. This in turn has corresponding effects on the lever ratios at the three-point hitch 14. The information to be transmitted to the control unit 54 in this respect is either input manually via the user interface 78 or else detected directly at the upper link 20 by the position sensor 74. Such a possibility is usually provided in any case for hydraulically length-adjustable upper links of conventional design.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. Method for ascertaining an occupancy state of a three-point hitch on an agricultural tractor, in which the three-point hitch for receiving an accessory or ancillary implement comprises, on the tractor side, an upper link pivotably attached to an upper fastening point and left-hand-side and right-hand-side lower links pivotably attached to left-hand-side and right-hand-side lower fastening points, which the left-hand-side and right-hand-side lower links can be raised and lowered by at least one hydraulic lifting cylinder by actuating a hitch valve, wherein when a constant flow cross section set at the hitch valve is identified, a control unit determines a speed of change in position occurring at the left-hand-side and right-hand-side lower links by a displacement sensor and also assesses the speed of change in position with regard to an ascertained deviation from a standard value predefined for an unoccupied state of the left-hand-side and right-hand-side lower links, wherein the control unit infers the presence of an accessory or ancillary implement attached to the left-hand-side and right-hand-side lower links if (i) the deviation occurring during lowering of the left-hand-side and right-hand-side lower links is greater in magnitude than a predefined upper limit value or (ii) the deviation occurring during lifting of the left-hand-side and right-hand-side lower links is lower in magnitude than a predefined lower limit value.

2. The method of claim 1, wherein the occupancy state is ascertained by the control unit when it is identified by evaluating travel or operating state information provided via a data communication system that the agricultural tractor is travelling straight ahead at a constant speed of travel on substantially inclination-free ground or is stationary thereon.

3. The method of claim 1, wherein the control unit terminates ascertaining of the occupancy state that has already started if it is identified by the control unit by evaluating the travel or operating state information provided via the data communication system that there is a change in the speed of travel, the direction of travel or the inclination of the ground that goes beyond a permissible tolerance range.

4. The method of claim 2, wherein the control unit, for assessing the inclination of the ground, evaluates inclination information or topography information, detected by sensor, of a navigation system permanently installed in the agricultural tractor or configured as a mobile terminal as a constituent part of the travel or operating state information.

5. The method of claim 1, wherein ascertaining of the occupancy state can be initiated by the control unit automatically when the agricultural tractor is put into operation, when it is identified during field cultivation that a headland has been reached, periodically after a predefined time period has elapsed or manually via a user interface.

6. The method of claim 1, wherein ascertaining of the deviation occurring in relation to the predefined standard value is limited to a linear range of constant speed of change in position occurring between the predefined initial position and the predefined end position of the left-hand-side and right-hand-side lower links.

7. The method of claim 1, wherein the control unit, taking into account geometry or lever ratios of the three-point hitch, the geometry or lever ratios being assumed to be known, categorizes the weight of an accessory or ancillary implement attached thereto in accordance with tensile force information provided by sensor and representing an action of load exerted on at least one of the left-hand-side and right-hand-side lower fastening points via the left-hand-side and right-hand-side lower links, on the basis of an estimation of the center of gravity position based thereon.

8. The method of claim 1, wherein the control unit, taking into account lever ratios of the three-point hitch, the lever ratios being assumed to be known, ascertains in magnitude the weight of the accessory or ancillary implement in accordance with tensile force information provided by sensor and representing an action of load exerted on at least one of the left-hand-side and right-hand-side lower fastening points via the left-hand-side and right-hand-side lower links, on the basis of an estimation of the center of gravity position based thereon in conjunction with information relating to a current upper link length.

9. An agricultural tractor, comprising:
a three-point hitch for receiving an accessory or ancillary implement including, on a tractor side, an upper link pivotably attached to an upper fastening point and left-hand-side and right-hand-side lower links pivotably attached to left-hand-side and right-hand-side lower fastening points, which the left-hand-side and right-hand-side lower links can be raised and lowered by at least one hydraulic lifting cylinder by actuating a hitch valve,
wherein when a constant flow cross section set at the hitch valve is identified, a control unit determines a speed of change in position occurring at the left-hand-side and right-hand-side lower links by a displacement sensor and assesses the speed of change in position with regard to an ascertained deviation from a standard value predefined for an unoccupied state of the left-hand-side and right-hand-side lower links,
wherein the control unit infers the presence of an accessory or ancillary implement attached to the left-hand-side and right-hand-side lower links if (i) the deviation occurring during lowering of the left-hand-side and right-hand-side lower links is greater in magnitude than a predefined upper limit value or (ii) the deviation occurring during lifting of the left-hand-side and right-hand-side lower links is lower in magnitude than a predefined lower limit value.

10. The agricultural tractor of claim 9, wherein an occupancy state is ascertained by the control unit when it is identified by evaluating travel or operating state information provided via a data communication system that the agricultural tractor is travelling straight ahead at a constant speed of travel on substantially inclination-free ground or is stationary thereon.

11. The agricultural tractor of claim 9, wherein the control unit terminates ascertaining of the occupancy state that has already started if it is identified by the control unit by evaluating the travel or operating state information provided via the data communication system that there is a change in the speed of travel, the direction of travel or the inclination of the ground that goes beyond a permissible tolerance range.

12. The agricultural tractor of claim 10, wherein the control unit, for assessing the inclination of the ground, evaluates inclination information or topography information, detected by sensor, of a navigation system permanently installed in the agricultural tractor or configured as a mobile terminal as a constituent part of the travel or operating state information.

13. The agricultural tractor of claim 9, wherein ascertaining of the occupancy state can be initiated by the control unit automatically when the agricultural tractor is put into operation, when it is identified during field cultivation that a headland has been reached, periodically after a predefined time period has elapsed or manually via a user interface.

14. The agricultural tractor of claim 9, wherein ascertaining of the deviation occurring in relation to the predefined standard value is limited to a linear range of constant speed of change in position occurring between the predefined initial position and the predefined end position of the left-hand-side and right-hand-side lower links.

15. The agricultural tractor of claim 9, wherein the control unit, taking into account geometry or lever ratios of the three-point hitch, the geometry or lever ratios being assumed to be known, categorizes the weight of an accessory or ancillary implement attached thereto in accordance with tensile force information provided by sensor and representing an action of load exerted on at least one of the left-hand-side and right-hand-side lower fastening points via the left-hand-side and right-hand-side lower links, on the basis of an estimation of the center of gravity position based thereon.

16. The agricultural tractor of claim 9, wherein the control unit, taking into account lever ratios of the three-point hitch, the lever ratios being assumed to be known, ascertains in magnitude the weight of the accessory or ancillary implement in accordance with tensile force information provided by sensor and representing an action of load exerted on at least one of the left-hand-side and right-hand-side lower fastening points via the left-hand-side and right-hand-side lower links, on the basis of an estimation of the center of gravity position based thereon in conjunction with information relating to a current upper link length.
